(19) United States
(12) Patent Application Publication
(10) Pub. No.: US 2020/0169884 A1
(43) Pub. Date: May 28, 2020

(54) METHODS AND DEVICES FOR QUERYING AUTHENTICATION INFORMATION OF A WIRELESS ACCESS POINT

(71) Applicant: SHANGHAI LIANSHANG NETWORK TECHNOLOGY CO., LTD., Shanghai (CN)

(72) Inventor: Peixi WU, Shanghai (CN)

(21) Appl. No.: 16/776,537

(22) Filed: Jan. 30, 2020

Related U.S. Application Data
(63) Continuation of application No. PCT/CN2018/096992, filed on Jul. 25, 2018.

(30) Foreign Application Priority Data
Aug. 2, 2017 (CN) 201710653369.6

(51) Int. Cl. H04W 12/06; H04W 48/16; H04W 48/14; H04W 84/12

(52) U.S. Cl. CPC H04W 12/06; H04W 84/12; H04W 48/14; H04W 48/16

(57) ABSTRACT

The present application provides a method and a device for querying authentication information of a wireless access point. The present disclosure enables acquisition of a determined target wireless access point according to a scan list of wireless access points transmitted by a user, and further acquires authentication information of the corresponding wireless access point and stores the same to a user mobile equipment. When establishing wireless access, authentication information of the corresponding wireless access point is first queried in the user mobile equipment. A query request is only submitted to a server if the mobile equipment does not have the corresponding authentication information. The present application reduces the number of interaction with the server to reduce the load of the server and save data traffic of the user mobile equipment. The present disclosure also guarantees a timely update of authentication information of wireless access points on the user mobile equipment.

### CROSS REFERENCE TO THE RELATED APPLICATION

This application is the continuation application of International Application No. PCT/CN2018/096992, filed on Jul. 25, 2018, which is based upon and claims priority to Chinese Patent Application No. 201710653369.6, filed on Aug. 2, 2017, the entire contents of which are incorporated herein by reference.

### FIELD

The present application relates to information technology, and more specifically relates to a method and a device for querying authentication information of a wireless access point.

### BACKGROUND

Currently, in a scenario where a user uses a mobile terminal equipment for wireless access, the user who keeps moving needs to access wireless access points with different coverage areas, and therefore is required to continuously acquire currently shared authentication information of accessible wireless access points. There are mainly two solutions in the prior art for providing authentication information of a wireless access point to a user. The first solution is to transmit authentication information of all or a large number of wireless access points to the user equipment in advance. The second solution is to query the authentication information of a wireless access point from the server in real time according to a list of scanned wireless access points. In the first solution, a large amount of authentication information of wireless access points is stored on the user equipment, so there is a large security risk. In the second solution, the authentication information of the wireless access point may be queried in real time. However, since the user's mobile terminal equipment scans the surrounding channels every 10 seconds, it is required to query the server for authentication information of the wireless access point again as long as the scanned wireless access point changes. If the query is not performed, the authentication information of the wireless access point may not be updated in time, while frequent query will not only increase the load at the server side, but also consume the data traffic at the user side.

### SUMMARY

Embodiments of the present application provides a method for querying authentication information of a wireless access point at a server, and the method includes

acquiring a query request transmitted by a user equipment and determining a target wireless access point according to the query request;

determining wireless access points associated with the target wireless access point according to an association rule;

acquiring authentication information of the target wireless access point and its associated wireless access points;

transmitting the authentication information to the user equipment.

Further, acquiring a query request transmitted by a user equipment and determining a target wireless access point according to the query request, comprises:

acquiring a query request transmitted by a user equipment, and the query request includes a scan list acquired by the user equipment and the scan list contains identifier information of the wireless access points scanned by the user equipment;

determining a wireless access point contained in the scan list as the target wireless access point.

Further, the method also comprises:

acquiring a scan list transmitted by a user equipment, and the scan list contains identifier information of the wireless access points scanned by the user equipment;

and the association rule includes:

wireless access points associated with a wireless access point include other wireless access points in one or more scan lists containing the wireless access point.

Further, the authentication information includes a hotspot password and/or an identifier indicating whether there is a hotspot password.

The present application further provides a method for querying authentication information of a wireless access point at a user equipment, and the method comprises:

determining a target wireless access point for query;

searching authentication information of the target wireless access point in an authentication information buffer, and the authentication information buffer is used to store authentication information of wireless access points acquired from a server;

reading the authentication information of the target wireless access point when the authentication information of the target wireless access point exists in the authentication information buffer;

transmitting a query request to the server when the authentication information of the target wireless access point does not exist in the authentication information buffer;

receiving and storing the authentication information of the target wireless access point and its associated wireless access points transmitted and determined based on the query request by the server.

Further, determining a target wireless access point for query comprises:

acquiring a scan list obtained via channel scanning, and the scan list contains identifier information of the wireless access points scanned by the user equipment;

determining a wireless access point contained in the scan list as the target wireless access point.

Further, the authentication information includes a hotspot password and/or an identifier indicating whether there is a hotspot password.

Further, storing the authentication information of the target wireless access point and its associated wireless access points transmitted and determined based on the query request by the server also comprises:

deleting authentication information from the authentication information buffer in chronological order after the content capacity of the authentication information buffer exceeds a preset upper limit.

Further, storing the authentication information of the target wireless access point and its associated wireless access points transmitted and determined based on the query request by the server also comprises:

after failing to connect to a corresponding wireless access point using authentication information in the authentication information buffer, deleting the authentication information from the authentication information buffer.

Based on another embodiment of the present application, the present application provides a device for querying authentication information of a wireless access point at a server, the device including a memory for storing computer program instructions and a processor for executing program instructions, and the computer program instructions, when executed by the processor, cause the device to perform the method for querying authentication information of a wireless access point at a server as aforementioned.

In addition, the present application provides a device for querying authentication information of a wireless access point at a user equipment, the device including a memory for storing computer program instructions and a processor for executing program instructions, and the computer program instructions, when executed by the processor, cause the device to perform the method for querying authentication information of a wireless access point at a user equipment as aforementioned.

The present application also provides a computer-readable medium having computer-readable instructions stored thereon, the computer-readable instructions being executable by a processor to implement the method for querying authentication information of a wireless access point at a server and the method for querying authentication information of a wireless access point at a user equipment as aforementioned.

Embodiments of the present application enables acquisition of a determined target wireless access point according to a scan list of wireless access points transmitted by a user, and further acquires authentication information of the corresponding wireless access point and stores the same to a user mobile equipment. When establishing wireless access, authentication information of the corresponding wireless access point is first queried in the user mobile equipment. A query request is only submitted to a server if the mobile equipment does not have the corresponding authentication information. In this way, the number of interaction with the server is reduced, to reduce the load of the server and saving data traffic of the user mobile equipment. The present application also guarantees a timely update of authentication information of wireless access points on the user mobile equipment.

### DESCRIPTIONS OF THE DRAWINGS

Embodiments of the present application will become more apparent by reading the detailed description of non-limiting embodiments with reference to the following drawings:

FIG. 1 is a flowchart of a method for querying authentication information of a wireless access point at a server provided for an embodiment of the present application.

FIG. 2 is a flowchart of a method for querying authentication information of a wireless access point at a user equipment provided for an embodiment of the present application.

FIG. 3 is a schematic diagram of an association rule generated according to a scan list submitted by a user equipment provided for an embodiment of the present application.

FIG. 4 is a schematic diagram of a target wireless access point and its associated wireless access points returned by a server provided for an embodiment of the present application.

FIG. 5 is a schematic diagram of a user equipment using authentication information in a local buffer to access corresponding wireless access point in a mobile scenario provided for an embodiment of the present application.

The identical or similar reference numerals in the drawings represent the identical or similar components.

### DETAILED EMBODIMENTS

The application is further described in detail below with reference to the accompanying drawings.

In a typical configuration of the present application, a terminal, a device of a service network and a trusted party all include one or more processors (CPUs), an input/output interface, a network interface and a memory.

The memory may include a non-permanent memory, a random access memory (RAM) and/or a non-volatile memory and the like in a computer-readable medium, such as a read-only memory (ROM) or a flash memory (flash RAM)). A memory is an example of a computer-readable medium.

A computer-readable medium comprises permanent and non-permanent, movable and non-movable media and may implement information storage by means of any method or technology. Information may be computer-readable instructions, data structures, program modules or other data. The examples of a computer storage medium include but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, compact disk read-only memory (CD-ROM), a digital versatile disc (DVD) or other optical storages, a magnetic cassette tape, and magnetic tape and magnetic disk storage or other magnetic storage devices or any other non-transmission media, which may be used to store information that may be accessed by a computing device. According to the definition herein, the computer-readable medium does not include a non-transitory computer-readable medium, such as a modulated data signal and a carrier.

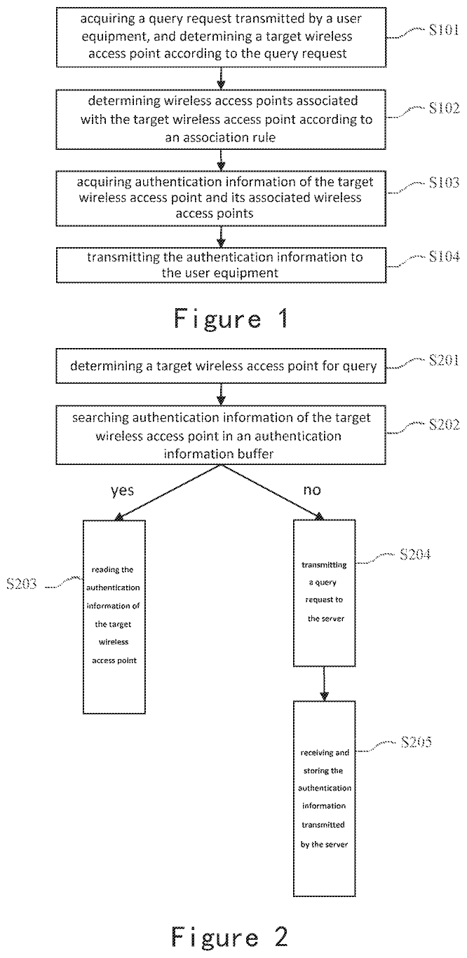

An embodiment of the present application provides a method for querying authentication information of a wireless access point at a server, as illustrated in FIG. 1. In one embodiment, the method comprises the following steps:

Step S101, acquiring a query request transmitted by a user equipment and determining a target wireless access point according to the query request;

Step S102, determining wireless access points associated with the target wireless access point according to an association rule;

Step S103, acquiring authentication information of the target wireless access point and its associated wireless access points;

Step S104, transmitting the authentication information to the user equipment.

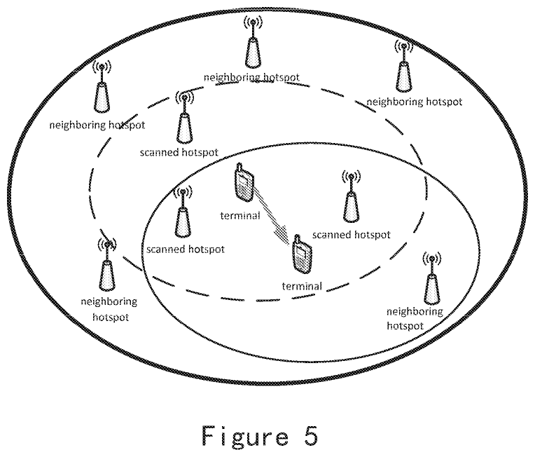

This solution is particularly suitable for scenarios where a user equipment enters the coverage area of different wireless access points and needs to acquire shared authentication information of accessible wireless access point when moving around. Multiple wireless access points associated with wireless access point in a scan list of wireless access points provided by the user equipment may be determined based on the scan list. Further, the acquired authentication information of the wireless access point and its associated wireless access points is returned to the user equipment for the user equipment to use the authentication information to access the corresponding wireless access point, as shown in FIG. 5. The terminal in the figure is the user equipment. The scanned hotspot is a wireless access point. The associated hotspot is a wireless access point that has a certain association with the scanned wireless access point.

Here, the user equipment refers to a mobile terminal equipment that may be carried by the user and may be used to connect to a wireless access point. The user equipment acquires an access permission to the wireless access point by providing the wireless access point with a corresponding access password to access the internet through the wireless access point.

A wireless access point, aka a wifi hotspot, is used to provide wireless users with network access services. It is a bridge between wireless and wired networks. It provides wireless signals that may cover a certain range, and the coverage may be spherical. The identifier of the wireless access point is an SSID (Service Set Identifier), and the user seeking wireless access uses SSIDs to identify different wireless access points. The access control of the wireless access point may be set in two ways: with password and without password. Generally, access to the wireless access point requires an access password to prevent unauthorized users from accessing. Currently, many business users such as restaurants, coffee shops, shopping malls, etc. provide free wireless access points available to other users. These free-to-use wireless access points also require users to know the access password to access. Therefore, there is a need for storing and querying authentication information such as access passwords of wireless access points, to facilitate multiple service providers to provide acquisition, storage, query, and update services of authentication information of wireless access points. The user seeking wireless access does not need to search the authentication information of the wireless access point, as long as the authentication information of the wireless access point that the user wants to connect may be acquired through the wireless access point authentication information service provided by the service provider. Further, the user may access the wireless access point and the internet.

The mobile terminal equipment periodically scans the surrounding wireless channels to acquire wireless access points for access. Because a wireless access point has a certain coverage range, there are often multiple wireless access points acquired by a user's mobile terminal equipment through wireless channel scanning. The multiple wireless access points acquired through scanning are the scan list acquired by the user equipment. The user may determine which wireless access point to connect by selecting the identifier of the wireless access point in the scan list.

Here, the wireless channel is also called a channel or a frequency band, which is a data signal transmission channel using a wireless signal (electromagnetic wave) as a transmission carrier. Wireless access points may operate on multiple wireless channels. The currently major wireless network equipment generally supports 13 channels regardless of whether it supports the 802.11b/g standard or the 802.11b/g/n standard. Although the center frequencies of the 13 channels are different, some of channels overlap with each other because each of the channels occupy a certain frequency range. Taking the channel division of the commonly used 2.4 GHz (=2400 MHz) frequency band as an example, each channel has a different center frequency. The effective width of each channel is 20 MHz, and there is also a 2 MHz forced isolation band (similar to the isolation band on the road). In one embodiment, channel 1 has a center frequency of 2412 MHz with a frequency range from 2401 to 2423 MHz, channel 2 has a center frequency of 2417 MHz with a frequency range from 2406 to 2428 MHz, channel 6 has a center frequency of 2437 MHz with a frequency range from 2426 to 2448 MHz, and channel 11 has a center frequency of 2462 MHz with a frequency range from 2451 to 2473 MHz. It can be seen that the frequency ranges used by the three channels 1, 6, and 11 are completely non-overlapping. That is, channels 1, 6 and 11 are the commonly known three non-overlapping channels. Wireless access points that respectively use these three channels do not cause signal interference.

The user equipment acquires a scan list by scanning the wireless channel. The scan list includes all searchable wireless access points. When displaying to users, usually only the identifier of the wireless access point, that is, the SSID is displayed. The identifier of the wireless access point is usually a readable string, facilitating the user to recognize different wireless access points. For example, a user acquires a scan list through a wireless channel scanning. The scan list includes three wireless access points, identified as AP1, AP2, and AP3.

After the user equipment acquires the scan list, in order to acquire the authentication information corresponding to the wireless access point in the scan list, the user equipment is required to submit a query request to a background server that stores a large amount of authentication information of wireless access points. The background server queries the corresponding authentication information before returning it to the user equipment. Here, the query request transmitted by the user equipment includes the scan list acquired through wireless channel scanning. The scan list contains the identifier of the wireless access point. At this time, the user equipment may have connected to other wireless access points or may not be connected to any wireless access point. If the user equipment is not connected to any wireless access point, the user equipment submits the query request to the background server through its own mobile data connection such as GPRS, 3G or 4G network. If the user equipment is connected to other wireless access points, the user equipment may submit the query request to the server through the connected wireless access point.

Here, the authentication information of the wireless access point includes a hotspot password and/or an identifier indicating whether there is a hotspot password. Hotspot password is an access password used to check the validity of a user's access. Only users who may provide a legitimate access password are allowed access. For example, the SSID of a wireless access point is “ChinaNet-S2G4”, and its corresponding access password is “123456”. When the user seeking wireless access connects to “ChinaNet-S2G4”, the user may only succeed in accessing after inputting the access password “123456”. In addition, the authentication information of the wireless access point may include additional information such as MAC address of a router, encryption mode of a router, and a communication channel, etc. Embodiments of the present application, the background server first acquires the identifier indicating whether the wireless access point is set with a hotspot password. If the identifier indicating whether there is a hotspot password in the authentication information of the wireless access point is true, it indicates that the wireless access point is set with a password, and then a next step is performed to acquire the corresponding hotspot password. If the identifier indicating whether there is a hotspot password in the authentication information of the wireless access point is false, it indicates that the wireless access point is not set with a password, then there is no need to perform the next step of acquiring the corresponding hotspot password. Contrast with the embodiments of the present application, in the prior art, the background server directly distributes the ID with password. Therefore, the embodiment of the present application may perform a database query according to actual needs and avoid unnecessary query operations, which reduces the consumption of database resources and improve query efficiency.

After receiving the query request submitted by the user equipment, the server needs to determine a wireless access point in the query request as the wireless access point to be queried for authentication information, i.e., the target wireless access point. The server queries the database that stores the authentication information of the wireless access points according to the target wireless access point, and acquires the corresponding authentication information. If there is no corresponding authentication information in the database, the corresponding authentication information is set to a null value. Here, the server performs the query by using the identifier of the target wireless access point. Since the query request contains multiple wireless access points, the target wireless access point may be one wireless access point selected by the user, or may be a set of wireless access points including multiple wireless access points.

After the server acquires the target wireless access point as the query input, it needs to extend the wireless access point for query before querying the authentication information. Since the wireless access points included in the scan list transmitted by the user equipment are merely the scan result acquired in a certain position when the user is moving around, the user is likely to have moved to somewhere out of the coverage of some wireless access points when receiving the returned authentication information of the wireless access point. However, if the user is within the coverage of some new wireless access points, a new scan list needs to be submitted to the server. Even if the user may temporarily stay to access the wireless access point with returned authentication information, a query request for a new wireless access point needs to be transmitted to the server as long as the user moves out of the coverage of the wireless access point. Therefore, continuous real-time authentication information query not only increases the pressure of the server to response, but also continuously consumes the data traffic at the user side, which is not a good solution.

In an embodiment of the present application, an association rule for wireless access points is used to extend the wireless access point for query to a set of wireless access points, including the target wireless access points and its associated wireless access points, as shown in FIG. 4. The terminal in the figure is the user equipment. The scanned hotspot is the wireless access point. Neighboring hotspots are the associated wireless access points. More wireless access point identifiers may be queried via one database query by using the extension of wireless access points, and authentication information of more wireless access points may be acquired and transmitted to the user equipment, to improve the query efficiency of the server and reducing the consumption of data traffic of the user equipment. Here, the embodiment of the present application further performs a de-duplication operation on the extended wireless access points. Duplicate wireless access points are removed according to the SSIDs of the wireless access points. Authentication information query is then performed on the set of de-duplicated wireless access points.

Here, wireless access points associated with a wireless access point is other wireless access points that have an association with the wireless access point. Other wireless access points that have an association with the wireless access point may refer to for example wireless access points that are geographically adjacent to the wireless access point and have a certain overlap in terms of the coverage of their wireless signals. The user may move from the coverage of one wireless access point to the coverage of its associated wireless access points when the user is moving. Therefore, continuous access to the Internet may be achieved by successively accessing the wireless access point and its associated wireless access points, reducing the possibility of disconnection from the Internet.

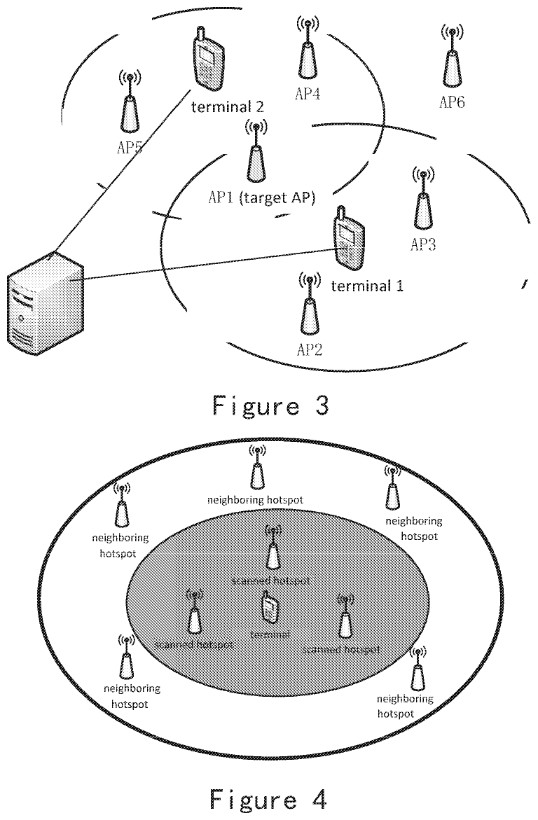

On the server side, the association rule between the wireless access point and its associated wireless access points is established in advance and updated continuously. For example, it may be updated based on a recently acquired scan list. In an embodiment of the present application, a method for determining wireless access points associated with a wireless access point is to determine all the wireless access points in one scan list transmitted by the user equipment as mutually associated wireless access points. That is, wireless access points associated with any wireless access point in one scan list are all the other wireless access points in the scan list except for the wireless access point itself. For example, in a scenario of authentication information query, a scan list received by the server which is transmitted by a user equipment terminal 1 is shown in FIG. 3. The scan list includes three wireless access points, identified as AP1, AP2, and AP3. AP1, AP2, and AP3 are wireless access points associated with each other. AP2 and AP3 are wireless access points associated with AP1. AP1 and AP3 are wireless access points associated with AP2. AP1 and AP2 are wireless access points associated with AP3. Thus, the server may establish a mapping table for each wireless access point and its associated wireless access points. When the user submits a query request, corresponding wireless access points associated with the submitted wireless access point is searched according to the submitted wireless access point. Because there might be a plurality of wireless access points which are submitted, there might be a plurality of resulting wireless access points associated with the submitted wireless access point acquired via the query. In one embodiment, the server establishes a mapping database table of the identifier (SSID) of the wireless access point SSID to the SSID of associated wireless access points.

In the above example, three association rules have been established on the server: “wireless access points associated with AP1 is {AP2, AP3}”, “wireless access points associated with AP2 is {AP1, AP3}”, and “wireless access points associated with AP3 is {AP1, AP2}”. When a user submits a query request to the server for the wireless access point AP1 that he wants to connect, the server first determines AP1 as the target wireless access point. Then association rules related to AP1 are queried in the association rule set. The searched association rule is “wireless access points associated with AP1 is {AP2, AP3}”. It may be known that AP2 and AP3 are wireless access points associated with AP1. If the wireless access point for which the user wants to acquire authentication information is {AP1, AP2}, the association rules acquired by the server by querying AP1 and AP2 are “wireless access points associated with AP1 is {AP2, AP3}”, “wireless access points associated with AP2 is {AP1, AP3}” respectively. The duplicate wireless access points in the set of wireless access points associated with {AP1, AP2} are removed, and finally the resulting wireless access points associated with {AP1, AP2} is {AP1, AP2, AP3}.

The association rules established on the server are not static. Since the information of the wireless access point changes frequently, the corresponding association rules also need to be continuously updated to adapt to the changing wireless access environment. The server still uses the scan list submitted by the user equipment as a basis for updating the association rule, and adds a new wireless access point associated with a wireless access point to the association rule. Wireless access points associated with a wireless access point include other wireless access points in one or more scan lists containing the wireless access point. Taking the above scenario as an example, a user equipment terminal 2 submits a new scan list, which includes three wireless access points identified as: AP1, AP4, and AP5, as shown in FIG. 3. After receiving the scan list, the server updates the association rule of AP1 to “wireless access points associated with AP1 is {AP2, AP3, AP4, AP5}”. Two new associated wireless access points AP4 and AP5 are added to the association rule of AP1. If a user submits an authentication information query request for AP1, the query result from the server for the wireless access points associated with AP1 is {AP2, AP3, AP4, AP5}.

The server extends the target wireless access point, and the result obtained is a set of wireless access points including the target wireless access point and its associated wireless access points. The number of wireless access points in this set may be one or more. Queries are then performed on the wireless access points in the set in the database for corresponding authentication information. The simplest authentication information contains only access password information. Taking the above scenario as an example, the server receives a query request for the wireless access point AP1 submitted by the user. After the association rule of AP1 is queried, it is obtained that the wireless access points associated with AP1 is {AP2, AP3, AP4, AP5}. Then query is performed on the set of wireless access points {AP1, AP2, AP3, AP4, AP5} for the corresponding access password. The corresponding information of wireless access points and access password {{“AP1”, “PASS1”}, {“AP2”, “PASS2”}, {“AP3”, “PASS3”}, {“AP4”, “PASS4”}, {“AP5”, “PASS5”}} is obtained.

After the server acquires the authentication information corresponding to the target wireless access point and its associated wireless access points, the server returns the authentication information to the user equipment that submitted the query request for storage in the user equipment.

An embodiment of the present application also provides a method for querying authentication information of a wireless access point at a user equipment, as illustrated in FIG. 2. In one embodiment, the method comprises the following steps:

S201, determining a target wireless access point for query;

S202, searching authentication information of the target wireless access point in an authentication information buffer, and the authentication information buffer is used to store authentication information of wireless access points acquired from a server;

S203, reading the authentication information of the target wireless access point when the authentication information of the target wireless access point exists in the authentication information buffer;

S204, transmitting a query request to the server when the authentication information of the target wireless access point does not exist in the authentication information buffer;

S205, receiving and storing the authentication information of the target wireless access point and its associated wireless access points transmitted and determined based on the query request by the server.

This solution is applicable to querying the locally stored wireless access point authentication information on the user equipment and submitting an authentication information query request for the target wireless access point to the server. One purpose of the present application is to reduce interaction with the server. Therefore, when receiving a query request from the user equipment for the first time, the server returns the authentication information of the submitted wireless access point and the associated wireless access points to the user equipment. The user equipment stores the received authentication information in a local buffer. When the scan list changes, authentication information of the wireless access point is first queried in the local buffer, and a query request is submitted to the server if no authentication information is searched.

This solution first acquires a list of wireless access points obtained by channel scanning. The list of wireless access points is the scan list. A wireless access point contained in the scan list is determined as the target wireless access point. The target wireless access point is a wireless access point whose authentication information is to be acquired, or may be a wireless access point that the user wants to connect. Therefore, the target wireless access point may be one or more, depending on specific situations. Here, the target wireless access points are distinguished by their respective identifier information.

After acquiring the target wireless access point, the user equipment needs to acquire authentication information of at least one wireless access point of the target wireless access points for wireless access. The solution provided by the embodiment of the present application is to first query the authentication information corresponding to the target wireless access point in the local authentication information buffer. If the corresponding authentication information may be searched, the corresponding authentication information may be directly read from the authentication information buffer, and there is no need to submit a query request for the target wireless access point to the server. If the user equipment is installed with a client APP provided by the wireless access authentication information service provider for the first time, there is no data in the local authentication information buffer. It is required to submit a corresponding wireless access point authentication information query request and fill it according to the authentication information returned by the server. In addition, only authentication information of part of the target wireless access points may exist in the local authentication information buffer. At this time, the strategy may be to choose not to transmit a query request to the server, and only connects to the corresponding wireless access points that have authentication information in the local authentication information buffer. It is also possible to transmit wireless access points without corresponding authentication information in the local authentication information buffer as the wireless access points for query to the server to acquire the authentication information of these wireless access points. Taking the above scenario as an example, the scan list acquired by the user equipment by channel scanning includes three wireless access points: AP1, AP2, and AP3. At this time, query is first performed in the local authentication information buffer, and there is a piece of data {“AP2”, “PASS2”} in the local authentication information buffer. Therefore, corresponding authentication information “PASS2” of the target wireless access point AP2 may be searched, so that the wireless access point AP2 may be connected by reading the authentication information from the buffer. A query request for corresponding authentication information of AP1 and AP3 may also be transmitted to the server.

If one or more wireless access points of the target wireless access points do not have corresponding authentication information in the local authentication information buffer, the user equipment may submit a query request for the target wireless access point to the server to acquire the authentication information. After receiving the authentication information of the target wireless access point and its associated wireless access points transmitted by the server, the user equipment stores the authentication information in the local authentication information buffer for future query. Taking the above scenario as an example, the user equipment acquires a scan list of wireless access points including three wireless access points AP1, AP2, and AP3. If the authentication information of any one of wireless access point AP1, AP2, and AP3 does not exist in the local authentication information buffer, the user equipment submits {AP1, AP2, AP3} as the target wireless access points to the server. The server expands it to {AP1, AP2, AP3, AP4, AP5}, where AP4 and AP5 are wireless access points associated with AP1. Query is performed on the database storing the authentication information and the authentication information {{“AP1”, “PASS1”}, {“AP3”, “PASS3”}, {“AP5”, “PASS5”}} are acquired. The user equipment receives the authentication information corresponding to AP1, AP3, and AP5 returned by the server and stores the authentication information in the authentication information buffer.

In order to avoid the problem of information leakage caused by the increase of the buffer by adding authentication information to the buffer and the performance problem of the decrease of the query speed of the buffer, an embodiment of the present application presets an upper limit for the capacity that may be used for the content of the local authentication information buffer. Therefore, when storing the newly acquired wireless access point authentication information, it is first determined that the upper limit of the capacity is not exceeded. If yes, the authentication information in the local authentication information buffer is deleted in chronological order. Specific standards for chronological order may be configured according to user's needs, such as the time of the last use, the time of the latest authentication information update, and so on.

In addition, if the authentication information stored in the buffer is found to fail to be used to connect to the corresponding wireless access point after use, it indicates that the authentication information of the wireless access point has changed and the current authentication information in the buffer has expired. Therefore, the expired authentication information should be cleared from the authentication information buffer. The wireless access point corresponding to the expired authentication information may be further submitted to the server to notify the server that the authentication information of the wireless access point has expired. The server then performs corresponding expiration processing on the wireless access point.

An embodiment of the present application also provides a device for querying authentication information of a wireless access point at a server, the device including a memory for storing computer program instructions and a processor for executing program instructions, and the computer program instructions, when executed by the processor, cause the device to perform the method for querying authentication information of a wireless access point at a server as aforementioned.

An embodiment of the present application also provides a device for querying authentication information of a wireless access point at a user equipment, the device including a memory for storing computer program instructions and a processor for executing program instructions, and the computer program instructions, when executed by the processor, cause the device to perform the method for querying authentication information of a wireless access point at a user equipment as aforementioned.

An embodiment of the present application also provides a computer-readable medium having computer-readable instructions stored thereon, the computer-readable instructions being executable by a processor to implement the method for querying authentication information of a wireless access point at a server and the method for querying authentication information of a wireless access point at a user equipment as aforementioned.

The embodiments by the present application enables acquisition of a determined target wireless access point according to a scan list of wireless access points transmitted by a user, and further acquires authentication information of the corresponding wireless access point and stores the same to a user mobile equipment. When establishing wireless access, authentication information of the corresponding wireless access point is first queried in the user mobile equipment. A query request is only submitted to a server if the mobile equipment does not have the corresponding authentication information. In this way, the number of interaction with the server is reduced, to reduce the load of the server and saving data traffic of the user mobile equipment. The present application also guarantees a timely update of authentication information of wireless access points on the user mobile equipment.

It should be noted that the present application may be implemented in software and/or a combination of software and hardware, for example, by using an application specific integrated circuit (ASIC), a general purpose computer, or any other similar hardware device. In one embodiment, the software program of the present application may be executed by a processor to implement the steps or functions described above. Likewise, the software programs (including related data structures) of the present application may be stored in a computer readable storage medium such as a RAM memory, a magnetic or optical drive or a floppy disk and the like. In addition, some of the steps or functions of the present application may be implemented in hardware, for example, as a circuit that cooperates with a processor to perform various steps or functions.

In addition, a portion of the present application may be embodied as a computer program product, such as computer program instructions, when executed by a computer, may invoke or provide a method in accordance with the present application. The program instructions for invoking the method of the present application may be stored in a fixed or removable storage medium, and/or transmitted by a data stream in a broadcast or other signal carrier medium, and/or stored in a working memory of the computer device in which the program instructions run. Herein, an embodiment in accordance with the present application includes a device including a memory for storing computer program instructions and a processor for executing program instructions, and the computer program instructions, when executed by the processor, cause the device to operate the aforementioned methods in accordance with various embodiments of the present application.

It is apparent that the present application is not limited to the details of the above-mentioned exemplary embodiments, and the present application may be implemented in other specific forms without departing the spirit or basic features of the present application. Therefore, the present embodiments are to be considered as illustrative and not restrictive. The scope of the present application is defined by the appended claims rather than the above-mentioned description, and therefore it is intended that all changes which fall within the meaning and range of equivalency of the claims are embraced in the present application. Any reference signs in the claims should not be construed as limiting the claims involved. In addition, it is apparent that the word “comprising” does not exclude other elements or steps, and the singular does not exclude the plural. Multiple devices stated in the device claims may also be implemented by one device through software or hardware.

What is claimed is:

1. A method for querying authentication information of a wireless access point at a server, the method comprising:
acquiring a query request transmitted by a user equipment and determining a target wireless access point according to the query request;
determining wireless access points associated with the target wireless access point according to an association rule;
acquiring authentication information of the target wireless access point and its associated wireless access points; and
transmitting the authentication information to the user equipment.

2. The method as recited in claim 1, wherein the acquiring of a query request transmitted by a user equipment and determining a target wireless access point according to the query request, comprising:
acquiring a query request transmitted by a user equipment, wherein the query request includes a scan list acquired by the user equipment and the scan list contains identifier information of the wireless access points scanned by the user equipment; and
determining a wireless access point contained in the scan list as the target wireless access point.

3. The method as recited in claim 1, the method further comprising:
acquiring a scan list transmitted by a user equipment, wherein the scan list contains identifier information of the wireless access points scanned by the user equipment;
wherein the association rule comprises:
wireless access points associated with a wireless access point comprise other wireless access points in one or more scan lists containing the wireless access point.

4. The method as recited in claim 1, wherein the authentication information comprises a hotspot password and an identifier indicating whether there is a hotspot password.

5. A method for querying authentication information of a wireless access point at a user equipment, the method comprising:
determining a target wireless access point for query;
searching authentication information of the target wireless access point in an authentication information buffer, wherein the authentication information buffer is used to store authentication information of wireless access points acquired from a server;
reading the authentication information of the target wireless access point when the authentication information of the target wireless access point exists in the authentication information buffer;
transmitting a query request to the server when the authentication information of the target wireless access point does not exist in the authentication information buffer; and
receiving and storing the authentication information of the target wireless access point and its associated wireless access points transmitted and determined based on the query request by the server.

6. The method as recited in claim 5, wherein the step of determining a target wireless access point for query, comprising:
acquiring a scan list obtained via channel scanning, wherein the scan list contains identifier information of the wireless access points scanned by the user equipment; and
determining a wireless access point contained in the scan list as the target wireless access point.

7. The method as recited in claim 5, wherein the authentication information includes a hotspot password and an identifier indicating whether there is a hotspot password.

8. The method as recited in claim 5, wherein the method further comprising:
deleting authentication information in the authentication information buffer in chronological order after content capacity of the authentication information buffer exceeds a preset upper limit.

9. The method as recited in claim 5, wherein the method further comprising:
after failing to connect to a corresponding wireless access point using authentication information in the authentication information buffer, deleting the authentication information from the authentication information buffer.

10. A device for querying authentication information of a wireless access point at a server, the device including a memory for storing computer program instructions and a processor for executing program instructions, wherein the computer program instructions, when executed by the processor, cause the device to:
acquire a query request transmitted by a user equipment and determining a target wireless access point according to the query request;
determine wireless access points associated with the target wireless access point according to an association rule;
acquire authentication information of the target wireless access point and its associated wireless access points; and
transmit the authentication information to the user equipment.
